(19) United States
(12) Patent Application Publication
(10) Pub. No.: US 2026/0162651 A1
(43) Pub. Date: Jun. 11, 2026

(54) Modular Integration of Automatic Speech Recognition and Large Language Models

(71) Applicant: Google LLC, Mountain View, CA (US)

(72) Inventors: Rao Ma, Mountain View, CA (US); Tongzhou Chen, Sunnyvale, CA (US); Kartik Audhkhasi, Mount Kisco, NY (US); Bhuvana Ramabhadran, Mt. Kisco, NY (US)

(73) Assignee: Google LLC, Mountain View, CA (US)

(21) Appl. No.: 19/413,370

(22) Filed: Dec. 9, 2025

Related U.S. Application Data
(60) Provisional application No. 63/730,958, filed on Dec. 11, 2024.

(51) Int. Cl. G10L 15/06; G06F 40/58; G10L 15/01; G10L 15/183; G10L 15/32

(52) U.S. Cl. CPC G10L 15/063; G06F 40/58; G10L 15/01; G10L 15/183; G10L 15/32; G10L 2015/0633; G10L 2015/0635

(57) ABSTRACT

The method includes fine-tuning a pre-trained audio encoder on supervised speech recognition training data. For each transcribed speech utterance, the method includes processing a corresponding sequence of audio features to generate a sequence of audio encoder posteriors over a first vocabulary of output labels using the fine-tuned audio encoder, determining a sequence of speech embeddings by computing a weighted sum of an input embedding table of a pre-trained LLM from the sequence of audio encoder posteriors, processing a concatenation of the sequence of speech embeddings and a sequence of text embeddings representative of a corresponding ground-truth transcription to generate a predicted sequence of output labels by the pre-trained LLM, and determining a cross-entropy loss term based on the predicted sequence of output labels and the ground-truth transcription. The method includes fine-tuning the pre-trained LLM based on each cross-entropy loss term.

### CROSS REFERENCE TO RELATED APPLICATIONS

This application claims priority under 35 U.S.C. § 119(e) to U.S. Provisional Application 63/730,958, filed on Dec. 11, 2024. The disclosure of this prior application is considered part of the disclosure of this application and is hereby incorporated by reference in its entirety.

### TECHNICAL FIELD

This disclosure relates to modular integration of automatic speech recognition and large language models.

### BACKGROUND

In the field of spoken language processing, large-scale pre-trained speech encoders and large language models (LLMs) have become widespread, demonstrating state-of-the-art performance across a range of tasks. Consequently, efforts have been made to effectively combine both types of models to further enhance performance on tasks such as automatic speech recognition (ASR) and automatic speech translation (AST). However, existing integration methods are subject to significant drawbacks, such as inflexibility or sub-optimal performance. One common approach is ASR error correction (AEC), where a cascaded system is employed. In this paradigm, the decoding hypotheses generated by an ASR system, such as an N-best list, are provided as text input to an LLM for subsequent correction. Although this method offers modularity by not requiring deep access to the ASR system, the approach remains constrained. The LLM has access only to limited contextual information, and this approach suffers from information loss by discarding the continuous speech representations in favor of text hypotheses. Such factors often result in sub-optimal performance.

### SUMMARY

One aspect of the disclosure provides a computer-implemented method that, when executed on data processing hardware, causes the data processing hardware to perform operations for modular integration of automatic speech recognition and large language models. The operations include obtaining a pre-trained audio encoder and a pre-trained large language model (LLM). The operations also include fine-tuning the pre-trained audio encoder on supervised speech recognition training data to teach the pre-trained audio encoder to generate audio encoder posteriors over a first vocabulary of output labels. The operations also include receiving training data that includes a corpus of transcribed speech utterances. Each transcribed speech utterance is paired with a corresponding ground-truth transcription and includes a corresponding sequence of audio features. For each corresponding transcribed speech utterance in the corpus of transcribed speech utterances, the operations include processing, using the fine-tuned audio encoder, the corresponding sequence of audio features to generate a corresponding sequence of audio encoder posteriors over the first vocabulary of output labels, determining a corresponding sequence of speech embeddings by computing a weighted sum of an input embedding table of the pre-trained LLM from the corresponding sequence of audio encoder posteriors, processing, by the pre-trained LLM, a concatenation of the corresponding sequence of speech embeddings and a sequence of text embeddings representative of the corresponding ground-truth transcription to generate a corresponding predicted sequence of output labels, and determining a cross-entropy loss term based on the corresponding predicted sequence of output labels and the corresponding ground-truth transcription. The operations also include fine-tuning the pre-trained LLM based on the cross-entropy loss terms determined for the transcribed speech utterances in the corpus of transcribed speech utterances.

Implementations of the disclosure may include one or more of the following optional features. In some implementations, parameters of the fine-tuned audio encoder are held fixed while fine-tuning the pre-trained LLM based on the cross-entropy loss terms. In some examples, the first vocabulary of output labels includes a vocabulary of the pre-trained LLM plus an additional special token that is not included in the vocabulary of the pre-trained LLM. Here, the pre-trained audio encoder may be pre-trained to encode speech representations for speech recognition or automatic speech translation tasks that use a second vocabulary of output labels different than the first vocabulary of output labels. In some implementations, the pre-trained audio encoder includes a stack of multi-head attention layers. In these implementations, the stack of multi-head attention layers may include Conformer layers or Transformer layers.

In some examples, the pre-trained audio encoder is pre-trained using a BERT-based Speech pre-Training with Random-projection Quantizer (BEST-RQ) training objective. In some implementations, the fine-tuned audio encoder includes an output layer to generate the corresponding sequence of audio encoder posteriors over the first vocabulary of output labels. In some examples, the corresponding sequence of audio encoder posteriors over the first vocabulary of output labels includes a probability distribution over possible word piece labels. In some implementations, the corpus of transcribed speech utterances includes multilingual transcribed speech utterances.

In some examples, the corresponding sequence of audio features of the transcribed speech utterance characterizes an utterance spoken in a source language and the corresponding ground-truth transcription includes translated text corresponding to a translation of the spoken utterance in a target language different than the source language. Here, processing the concatenation of the corresponding sequence of speech embeddings and the sequence of text embeddings representative of the corresponding ground-truth transcription by the pre-trained LLM further includes processing the concatenation of the corresponding sequence of speech embeddings and the sequence of text embeddings representative of the corresponding ground-truth transcription conditioned on a natural language automatic speech translation (AST) prompt by the pre-trained LLM to generate the corresponding predicted sequence of output labels. The natural language AST prompt instructs the pre-trained LLM to generate the corresponding predicted sequence of output labels in the target language. In these examples, the corresponding sequence of audio encoder posteriors over the first vocabulary of output labels may be in the source language.

In some implementations, the pre-trained audio encoder is pre-trained by receiving audio encoder pre-training data that includes a corpus of un-transcribed speech utterances. Each un-transcribed speech utterance is not paired with a corresponding transcription. For each corresponding un-transcribed speech utterance in the corpus of un-transcribed speech utterances, the operations include generating, at each of a plurality of output steps, using a random-projection quantizer, a target quantized vector token and a target token index for a corresponding audio feature in a sequence of audio features associated with the corresponding un-transcribed speech utterance. Here, the target token index maps the corresponding audio feature to the target quantized vector token stored in one or more codebooks. After masking a subset of the audio features in the sequence of audio features associated with the corresponding un-transcribed speech utterance, the operations include generating, by the audio encoder, contrastive context vectors from corresponding masked audio features, and deriving a contrastive loss term between the contrastive context vectors at the masked positions and the target token index. In these implementations, pre-training the audio encoder is based on the contrastive loss terms.

In these implementations, the audio encoder pre-training data may further include a corpus of unspoken textual utterances and another corpus of transcribed speech utterances. Here, each unspoken textual utterance is not paired with any corresponding spoken utterance and each transcribed speech utterance in the other corpus of transcribed speech utterances is paired with a corresponding transcription. Here, the pre-trained audio encoder is further pre-trained by generating, using an alignment model, a corresponding alignment output for each unspoken textual utterance. At each of a plurality of output steps for each alignment output, the operations include generating, using an auxiliary decoder, a first probability distribution over possible speech recognition hypotheses for the corresponding alignment output and determining an alignment output loss term based on the first probability distribution over possible speech recognition hypotheses and the unspoken textual utterance corresponding to the alignment output. At each of a plurality of output steps for each transcribed non-synthetic speech utterance, the operations include generating, using the auxiliary decoder, a second probability distribution over possible speech recognition hypotheses for the corresponding transcribed non-synthetic speech utterance, determining a speech loss term based on the second probability distribution over possible speech recognition hypotheses and the corresponding transcription paired with the transcribed non-synthetic speech utterance, and pre-training the audio encoder based on the contrastive loss term, the alignment output loss term, and the speech loss term.

Another aspect of the disclosure provides a system that includes data processing hardware and memory hardware storing instructions that when executed on the data processing hardware causes the data processing hardware to perform operations. The operations include obtaining a pre-trained audio encoder and a pre-trained large language model (LLM). The operations also include fine-tuning the pre-trained audio encoder on supervised speech recognition training data to teach the pre-trained audio encoder to generate audio encoder posteriors over a first vocabulary of output labels. The operations also include receiving training data that includes a corpus of transcribed speech utterances. Each transcribed speech utterance is paired with a corresponding ground-truth transcription and includes a corresponding sequence of audio features. For each corresponding transcribed speech utterance in the corpus of transcribed speech utterances, the operations include processing, using the fine-tuned audio encoder, the corresponding sequence of audio features to generate a corresponding sequence of audio encoder posteriors over the first vocabulary of output labels, determining a corresponding sequence of speech embeddings by computing a weighted sum of an input embedding table of the pre-trained LLM from the corresponding sequence of audio encoder posteriors, processing, by the pre-trained LLM, a concatenation of the corresponding sequence of speech embeddings and a sequence of text embeddings representative of the corresponding ground-truth transcription to generate a corresponding predicted sequence of output labels, and determining a cross-entropy loss term based on the corresponding predicted sequence of output labels and the corresponding ground-truth transcription. The operations also include fine-tuning the pre-trained LLM based on the cross-entropy loss terms determined for the transcribed speech utterances in the corpus of transcribed speech utterances.

Implementations of the disclosure may include one or more of the following optional features. In some implementations, parameters of the fine-tuned audio encoder are held fixed while fine-tuning the pre-trained LLM based on the cross-entropy loss terms. In some examples, the first vocabulary of output labels includes a vocabulary of the pre-trained LLM plus an additional special token that is not included in the vocabulary of the pre-trained LLM. Here, the pre-trained audio encoder may be pre-trained to encode speech representations for speech recognition or automatic speech translation tasks that use a second vocabulary of output labels different than the first vocabulary of output labels. In some implementations, the pre-trained audio encoder includes a stack of multi-head attention layers. In these implementations, the stack of multi-head attention layers may include Conformer layers or Transformer layers.

In some examples, the pre-trained audio encoder is pre-trained using a BERT-based Speech pre-Training with Random-projection Quantizer (BEST-RQ) training objective. In some implementations, the fine-tuned audio encoder includes an output layer to generate the corresponding sequence of audio encoder posteriors over the first vocabulary of output labels. In some examples, the corresponding sequence of audio encoder posteriors over the first vocabulary of output labels includes a probability distribution over possible word piece labels. In some implementations, the corpus of transcribed speech utterances includes multilingual transcribed speech utterances.

In some examples, the corresponding sequence of audio features of the transcribed speech utterance characterizes an utterance spoken in a source language and the corresponding ground-truth transcription includes translated text corresponding to a translation of the spoken utterance in a target language different than the source language. Here, processing the concatenation of the corresponding sequence of speech embeddings and the sequence of text embeddings representative of the corresponding ground-truth transcription by the pre-trained LLM further includes processing the concatenation of the corresponding sequence of speech embeddings and the sequence of text embeddings representative of the corresponding ground-truth transcription conditioned on a natural language automatic speech translation (AST) prompt by the pre-trained LLM to generate the corresponding predicted sequence of output labels. The natural language AST prompt instructs the pre-trained LLM to generate the corresponding predicted sequence of output labels in the target language. In these examples, the corresponding sequence of audio encoder posteriors over the first vocabulary of output labels may be in the source language.

In some implementations, the pre-trained audio encoder is pre-trained by receiving audio encoder pre-training data that includes a corpus of un-transcribed speech utterances. Each un-transcribed speech utterance is not paired with a corresponding transcription. For each corresponding un-transcribed speech utterance in the corpus of un-transcribed speech utterances, the operations include generating, at each of a plurality of output steps, using a random-projection quantizer, a target quantized vector token and a target token index for a corresponding audio feature in a sequence of audio features associated with the corresponding un-transcribed speech utterance. Here, the target token index maps the corresponding audio feature to the target quantized vector token stored in one or more codebooks. After masking a subset of the audio features in the sequence of audio features associated with the corresponding un-transcribed speech utterance, the operations include generating, by the audio encoder, contrastive context vectors from corresponding masked audio features, and deriving a contrastive loss term between the contrastive context vectors at the masked positions and the target token index. In these implementations, pre-training the audio encoder is based on the contrastive loss terms.

In these implementations, the audio encoder pre-training data may further include a corpus of unspoken textual utterances and another corpus of transcribed speech utterances. Here, each unspoken textual utterance is not paired with any corresponding spoken utterance and each transcribed speech utterance in the other corpus of transcribed speech utterances is paired with a corresponding transcription. Here, the pre-trained audio encoder is further pre-trained by generating, using an alignment model, a corresponding alignment output for each unspoken textual utterance. At each of a plurality of output steps for each alignment output, the operations include generating, using an auxiliary decoder, a first probability distribution over possible speech recognition hypotheses for the corresponding alignment output and determining an alignment output loss term based on the first probability distribution over possible speech recognition hypotheses and the unspoken textual utterance corresponding to the alignment output. At each of a plurality of output steps for each transcribed non-synthetic speech utterance, the operations include generating, using the auxiliary decoder, a second probability distribution over possible speech recognition hypotheses for the corresponding transcribed non-synthetic speech utterance, determining a speech loss term based on the second probability distribution over possible speech recognition hypotheses and the corresponding transcription paired with the transcribed non-synthetic speech utterance, and pre-training the audio encoder based on the contrastive loss term, the alignment output loss term, and the speech loss term.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIGS. 2A and 2B are schematic views of an example training process for pre-training an audio encoder of a speech recognition model.

FIG. 3 is a schematic view of an example training process for fine-tuning a pre-trained audio encoder.

FIG. 4 is a schematic view of an example training process for fine-tuning a pre-trained large language model (LLM).

FIG. 5 is a flowchart of an example arrangement of operations for a computer-implemented method of fine-tuning a pre-trained audio encoder and a pretrained large language model (LLM) for speech recognition tasks.

FIG. 6 is a schematic view of an example computing device that may be used to implement the systems and methods described herein.

Like reference symbols in the various drawings indicate like elements.

### DETAILED DESCRIPTION

In the field of spoken language processing, large-scale pre-trained models, such as speech encoders and large language models (LLMs), have become widespread. The objective is to effectively combine these models, leveraging the advanced speech processing capabilities of encoders and the extensive world knowledge and language understanding of LLMs. An integrated system that successfully bridges these modalities may achieve state-of-the-art performance on a range of complex tasks, including automatic speech recognition (ASR) and automatic speech translation (AST). The overall utility of such a combined system is directly dependent on the quality and efficiency of the method used to connect the speech and text modalities.

A persistent challenge in bridging these models is the sub-optimal performance of common cascaded approaches. One such method is ASR error correction (AEC), where a speech encoder first generates text hypotheses, which are then fed to an LLM for refinement. This paradigm suffers from information loss because the LLM receives only discrete text hypotheses and lacks access to the underlying probabilistic and continuous acoustic representations. This information bottleneck limits the ability of the LLM to effectively correct errors or understand nuanced acoustic detail, resulting in sub-optimal performance.

From an architectural standpoint, an alternative approach involves using continuous speech prompts, where vectors from the speech encoder are fed directly to the LLM via a trained connection network. While this method mitigates the information loss issue, this method introduces inflexibility and sacrifices modularity. The LLM becomes tightly coupled to the specific speech encoder the LLM was trained with, as the LLM has learned to interpret the unique output space of that particular encoder. Consequently, the speech encoder cannot be updated, replaced, or adapted to a new domain without requiring a complete, and computationally expensive, retraining of the LLM. This lack of modularity is a significant operational burden in real-world applications where models must be independently updated.

Accordingly, implementations herein are directed towards a training process for fine-tuning a pre-trained sequence processing neural network model, such as a large language model (LLM). While implementations herein will refer to the pre-trained sequence processing neural network model as a pre-trained LLM, the aspects of the present disclosure may be applicable to other types of pre-trained sequence processing neural network models. The training process includes obtaining a pre-trained audio encoder and a pre-trained LLM. The audio encoder is fine-tuned on supervised speech recognition data to teach the pre-trained audio encoder to generate audio encoder posteriors over a first vocabulary of output labels. For each transcribed speech utterance in a corpus of transcribed speech utterances, the training process processes, using the fine-tuned audio encoder, a corresponding sequence of audio features to generate a corresponding sequence of audio encoder posteriors, determines a corresponding sequence of speech embeddings by computing a weighted sum of an input embedding table of the pre-trained LLM from the corresponding sequence of audio encoder posteriors, processes, by the pre-trained LLM, a concatenation of the corresponding sequence of speech embeddings and a sequence of text embeddings representative of a corresponding ground-truth transcription to generate a corresponding predicted sequence of output labels, and determines a cross-entropy loss term based on the corresponding predicted sequence of output labels and the corresponding ground-truth transcription. The training process fine-tunes the pre-trained LLM based on the cross-entropy loss terms determined for the transcribed speech utterances in the corpus of transcribed speech utterances.

The automated generation of speech embeddings from audio encoder posteriors by the training process resolves the information loss present in other approaches. Instead of passing limited text-based hypotheses, the training process provides the LLM with a full probability distribution over the vocabulary for each time step. This distribution, in the form of CTC posteriors, preserves a vastly richer set of information about the original utterance, including alternative token predictions and the corresponding confidences. By using the posteriors to determine a weighted sum of the embedding table of the LLM, the training process reconstructs pseudo-audio embeddings that are already aligned with the input space of the LLM, thereby mitigating information loss and enabling superior performance compared to AEC methods.

Moreover, the training process improves architectural flexibility and computational efficiency by enforcing modularity between the speech encoder and the LLM. The audio encoder posteriors serve as a standardized interface, unlike the internal vector representations used in continuous speech prompt methods. The LLM is trained to interpret the standardized probability matrix, not the unique output space of a specific encoder. This disentanglement allows the speech encoder to be “switched” or updated in a zero-shot fashion, meaning the LLM does not require retraining when the encoder component is replaced. This modularity is a valuable property for real-world applications reducing the computational and operational overhead associated with model updates and domain adaptation.

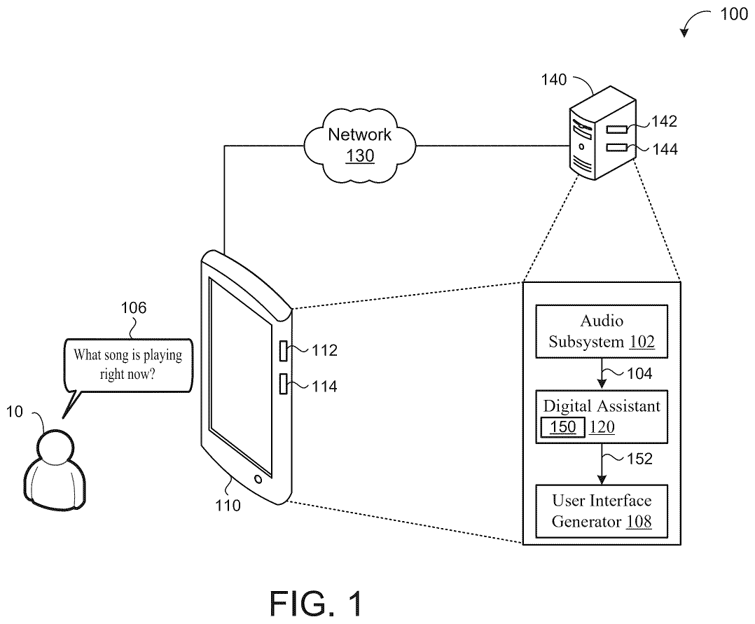

Referring now to FIG. 1, in some implementations, a system 100 includes a user device 110 in communication with a remote computing system 140 via a network 130. The user device 110 includes data processing hardware 112 in communication with memory hardware 114. The remote computing system 140 includes data processing hardware 142 in communication with memory hardware 144. The user device 110 may be any computing device capable of interacting with a user, such as a smartphone, tablet, smart speaker, or wearable device. The network 130 may include various wireless and wireline networks, such as the Internet, cellular networks, or local area networks.

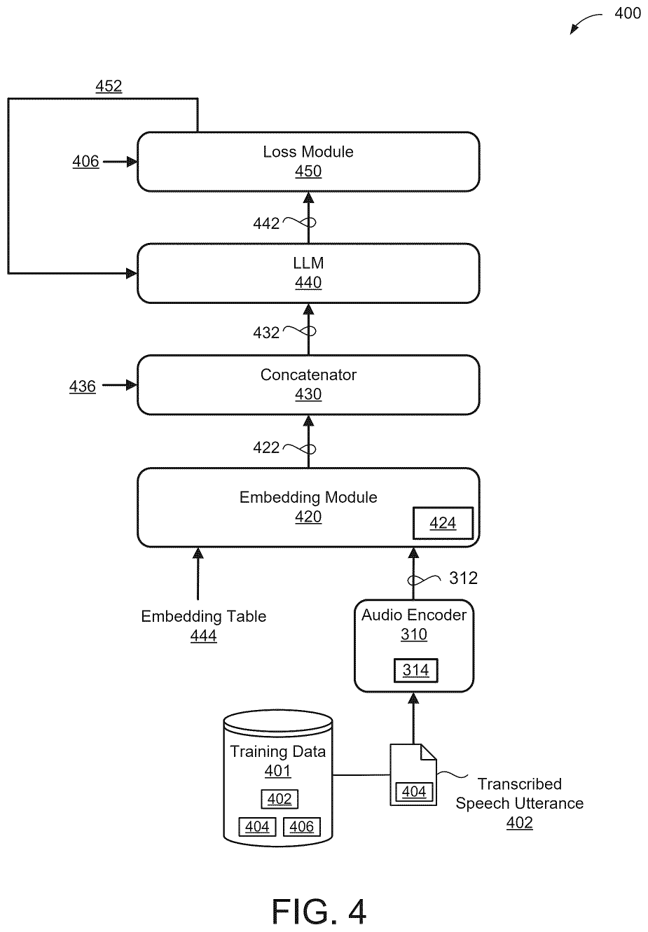

The user device 110 and/or the remote computing system 140 may execute a digital assistant 120 that employs a fine-tuned sequence processing neural network model 150 to perform language processing tasks. In some examples, the fine-tuned sequence processing neural network model 150 includes a large language model (LLM). For simplicity, the present disclosure will refer to the sequence processing neural network model 150 as a fine-tuned LLM. As will become apparent, the fine-tuned LLM 150 is a result of a fine-tuning process 400 (FIG. 4) that bridges speech and text modalities using audio encoder posteriors. The fine-tuning process 400 utilizes a pre-trained sequence processing neural network 440. While the pre-trained sequence processing neural network 440 is broadly a neural network configured to process sequences of data (e.g., a Transformer-based model), for the sake of simplicity, the pre-trained sequence processing neural network 440 will be referred to herein as a pre-trained LLM 440. A user 10 may speak or provide as text a query 106 to the digital assistant 120 to initiate a task, such as transcription, translation, or a general query. An audio subsystem 102 may process the query 106 to generate a corresponding sequence of acoustic frames 104 (e.g., Mel-frequency cepstral coefficients or log-mel filterbank energies).

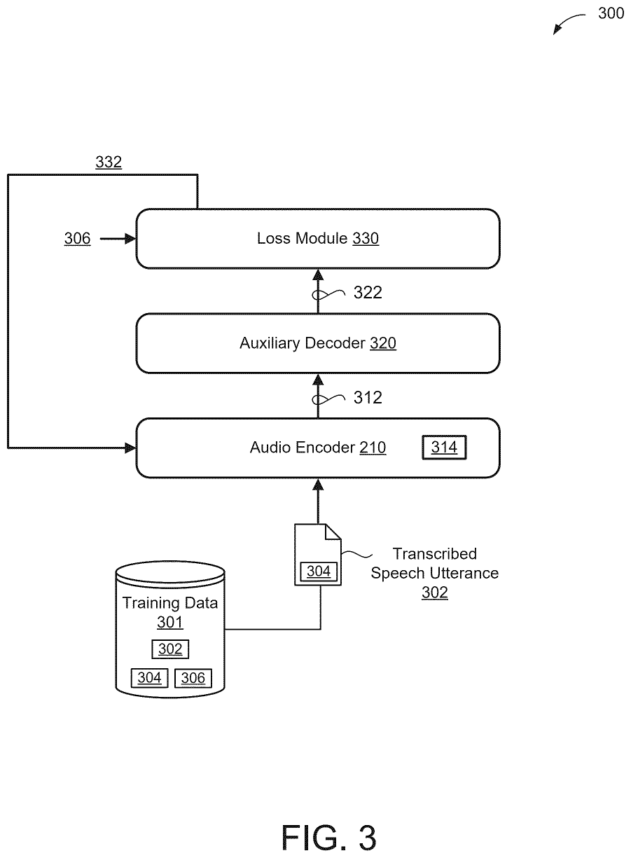

The fine-tuned LLM 150 processes the sequence of acoustic frames 104 to generate an output 152. In some implementations, the fine-tuned LLM 150 leverages a fine-tuned audio encoder 310 (FIG. 3) to convert the acoustic frames 104 into speech embeddings that are compatible with the input space of the fine-tuned LLM 150. A user interface generator 108 may audibly present the output 152 to the user 10, for example, by synthesizing speech from the output 152, or visually output the output 152 on a display associated with the user device 110.

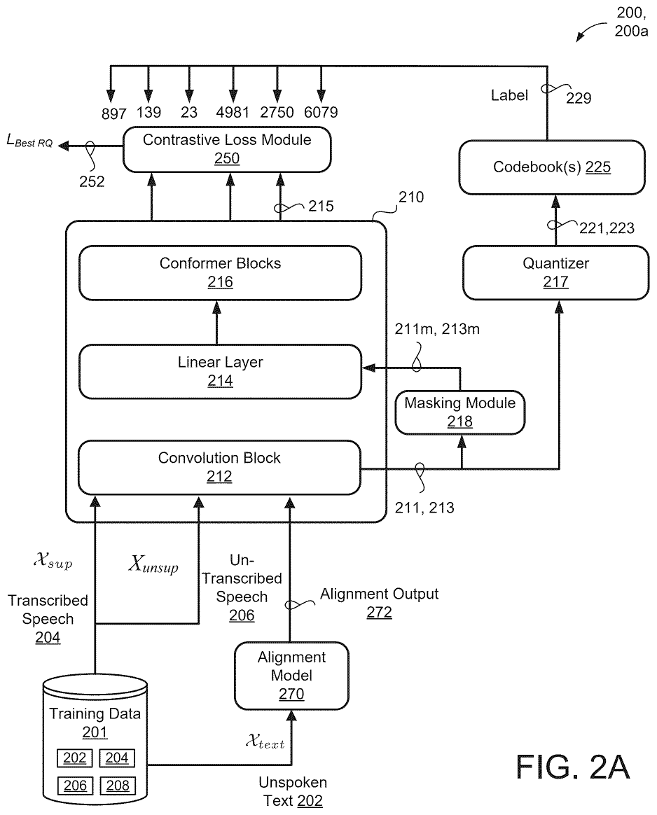

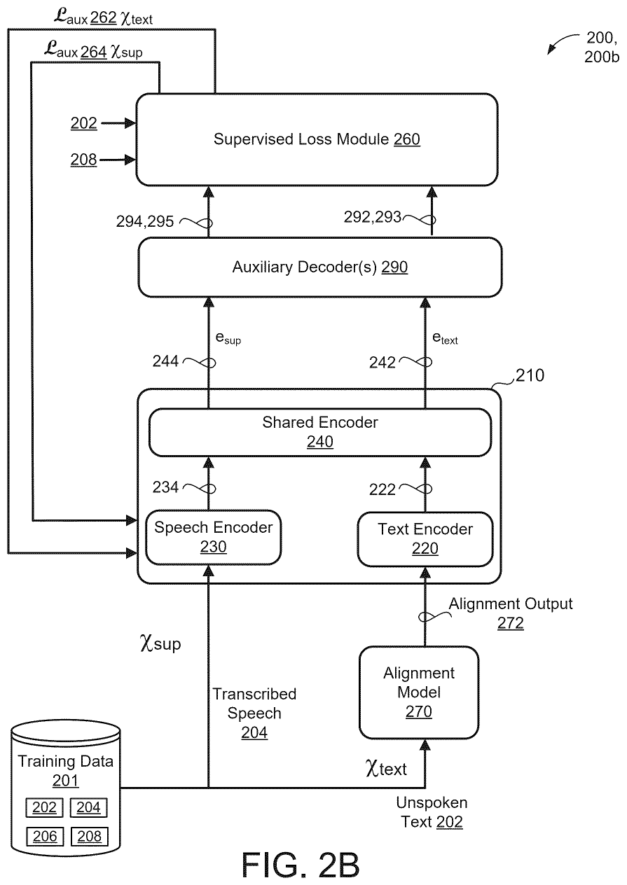

FIGS. 2A and 2B illustrate an example pre-training process 200 for pre-training the audio encoder 210 of an example speech recognition model. The pre-training process 200 pre-trains the audio encoder 210 on audio encoder pre-training data 201. The pre-trained audio encoder 210 is pre-trained to encode speech representations for speech recognition or automatic speech translation tasks that use a second vocabulary of output labels different than a first vocabulary of output labels. As will become apparent, the first vocabulary of output labels are learned during a fine-tuning process 300. The audio encoder pre-training data 201 may include a corpus of multilingual unspoken textual utterances (Xₜₑₓₜ) 202, a corpus of multilingual transcribed non-synthetic speech utterances (Xₛᵤₚ) 204, and a corpus of multilingual un-transcribed non-synthetic speech utterances (Xᵤₙₛᵤₚ) 206. The multilingual training utterances may include utterances from a plurality of different languages, for example, hundreds of different languages. Each unspoken textual utterance 202 includes text-only data (i.e., unpaired data) such that each unspoken textual utterance 202 is not paired with any corresponding spoken audio representation (i.e., speech) of the utterance. The unspoken textual utterance 202 may include any sequence of text chunks including words, word pieces, phonemes, and/or graphemes. Each un-transcribed non-synthetic speech utterance 206 includes audio-only data (i.e., unpaired data) such that the un-transcribed non-synthetic speech utterance 206 is not paired with any corresponding transcription. On the other hand, each transcribed non-synthetic speech utterance 204 includes a corresponding transcription 208 paired with a corresponding non-synthetic speech representation of the corresponding transcribed non-synthetic speech utterance 204.

For simplicity, the pre-training process 200 includes a contrastive self-supervised loss part 200a (also referred to as simply “contrastive loss part 200a”) (FIG. 2A) and a supervised loss part 200b (FIG. 2B). The pre-training process 200 pre-trains the audio encoder 210 on a total loss (Lₜₜₛ₄ₚᵣₑₜᵣₐᵢₙ₂) based on: contrastive losses (L_{w2v}) 252 derived using the contrastive self-supervised loss part 200a from the unspoken training text utterances (Xₜₑₓₜ) 202, the corpus of transcribed non-synthetic speech utterances (Xₛᵤₚ) 204, and the un-transcribed non-synthetic speech utterances (Xᵤₙₛᵤₚ) 206; and supervised losses (Lx) 262, 264 derived using the supervised loss part 200b from the unspoken training text utterances (Xₜₑₓₜ) 202 and the transcribed non-synthetic speech utterances (Xₛᵤₚ) 204.

Referring now specifically to FIG. 2A, the contrastive self-supervised loss part 200a of the pre-training process 200 may employ an alignment model 270 that is configured to generate, at each of a plurality of output steps, alignment outputs (i.e., textual representation) 272 for each of a plurality of unspoken textual utterances 202. The unspoken textual utterances 202 includes unspoken text that is text-only data, i.e., unpaired data, such that each unspoken textual utterance (Xₜₑₓₜ) 202 is not paired with any synthesized or non-synthesized speech. Accordingly, the alignment model 270 generates a corresponding alignment output 272 for each of the unspoken textual utterances 202.

In some implementations, the audio encoder 210 includes a speech encoder 230 and a text encoder 220, described in more detail with reference to FIG. 2B. In the example shown, the audio encoder 210 (alternatively the speech encoder 230 or the text encoder 220 (FIG. 2B)) includes a Conformer encoder including a stack of multi-head attention layers each of which includes a series of multi-headed self attention, depthwise convolution, and feed-forward layers. Specifically, the stack of multi-head attention layers may include Conformer layers or Transformer layers. The audio encoder 210 may be split into a feature encoder, including a convolution subsampling block 212, and a context network, including a linear layer 214 and a stack of Conformer blocks 216. In some implementations, the convolution subsampling block 212 has two two-dimensional-convolution layers, each with stride (2, 2), yielding a 4× reduction in the feature sequence length. The convolution subsampling block 212 receives, as input, a sequence of input features/vectors (e.g., mel-frequency spectrograms such as the acoustic frames 104 of FIG. 1) associated with each transcribed non-synthetic speech utterance 204 and each un-transcribed non-synthetic speech utterance 206, and generates, as output, for each of a plurality of output steps, an encoded audio feature 211 that corresponds to a respective one of the transcribed non-synthetic speech utterances 204 or a respective one of the un-transcribed non-synthetic speech utterances 206. The convolution subsampling block 212 may receive, as input, each alignment output 272 and generate, as output, for each of the plurality of output steps, an encoded textual feature 213 that corresponds to a respective one of the alignment outputs 272.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m, 213m (or encoded features 211, 213 not chosen by the masking module 218) and outputs corresponding contrastive context vectors (i.e., encoded representation) 215 from masked encoded features 211m, 213m.

Moreover, a quantizer 217 receives the encoded features 211, 213 as input, and applies random projections to generate, at each of the plurality of output steps, a target quantized vector token 221 and a target token index 223 for a corresponding encoded feature 211, 213 as output. As such, the quantizer 217 generates the target quantized vector token 221 and the target token index 223 using the encoded features 211, 213 that do not include any masking. Here, the quantizer 217 generates the target quantized vector tokens 221 according to

$${q}_{i} ∈ {\{ {e}_{j} \}}_{j = 1}^{V} .$$

The quantizer 217 maps encoded features 211, 213 into a finite set of target quantized vector tokens 221 in a codebook, each token acting as a discrete representation of the underlying features. The representative target quantized vector tokens 221 generated by the quantizer 217 represent a finite set of representative target quantized vector tokens referred to as a codebook 225. The target token index 223 maps each corresponding encoded feature 211, 213 to a respective one of the target quantized vector tokens 221 stored in the codebook 225. In some implementations, the quantizer 217 projects the target context vector 221 to a randomly initialized codebook 225 that maps the target context vectors 223 to discrete labels 229 by finding a nearest vector in the codebook 225. Here, the target context vector 221 collectively refers to the target quantized vector tokens 221 and the target token index 223. Notably, the quantizer 217 includes a random-projection quantizer 217 configured to randomly initialize a matrix and the codebook 225. The random-projection quantizer 217 uses the matrix to project the encoded features 211, 213 into the target context vectors 223 and uses the codebook 225 to find a nearest vector where an index of the vector includes the label 229. In some examples, the codebook 225 finds the nearest vector by determining a cosine similarity as a distance measurement.

Thereafter, a contrastive loss module 250 derives a contrastive loss term (L_{Best RQ}) 252 between the contrastive context vectors 215 at the masked positions and the target context vectors 223 as follows.

$$L = - l o g \frac{exp ( sim ( {c}_{t ,} {q}_{t} ) / k )}{{\sum }_{\tilde{q} \sim {Q}_{t}} exp ( sim ( {c}_{t} , \tilde{q} ) / k )} \qquad ( 1 )$$

where cₜ is contrastive context vector 215 centered over a masked time step t and qₜ represents a target context vector 223 at the time step t in a set of K+1 candidate target context vectors 223 which includes qₜ and K distractors. Distractors may be uniformly sampled from other masked time steps of the same utterance. Advantageously, the contrastive loss 252 represents a Bidirectional Encoder Representations from Transformers (BERT)-based Speech pre-Training with Random Projection Quantizer (BEST-RQ) loss does not require an additional quantization module that other contrastive losses (e.g., w2v-BERT) require. As such, since the BEST-RQ loss does not require the additional quantization module, the BEST-RQ loss enables the speech recognition model to be more scalable for multiple languages during pre-training.

In some implementations, the contrastive loss module 250 derives the contrastive loss term 252 directly between the contrastive context vectors 215 at the masked positions and the target token index 223. In such implementations, rather than determining a geometric similarity between vectors as shown in Equation (1), the audio encoder 210 utilizes a projection layer to map the contrastive context vectors 215 to a set of logits corresponding to the size of the codebook 225. Here, the loss module 250 determines the contrastive loss term 252 as a cross-entropy loss (or negative log-likelihood) between the projected logits and the target token index 223, where the target token index 223 serves as the ground-truth label. By maximizing the probability of the target token index 223 relative to other indices in the codebook 225, the contrastive loss module 250 effectively contrasts the correct quantized representation against incorrect representations.

The contrastive loss 252 is optimized between the contrastive context vectors 215 at the masked positions and the target context vectors 223. After the audio encoder 210 converges on the un-transcribed non-synthetic speech utterances 206, the pre-training procedure is repeated on both the alignment outputs 272 corresponding to the unspoken textual utterance 202 and the transcribed non-synthetic speech utterances 204. Thus, the contrastive loss 252 is optimized for both real/human (non-synthetic) and unspoken textual utterances 202 represented by alignment outputs 272, with additional auxiliary losses on the transcribed non-synthetic speech utterances 204 and the alignment outputs 272 as described in greater detail below with reference to FIG. 2B. Accordingly, the pre-training process 200 pre-trains the audio encoder 210 on the derived contrastive loss 252 applied on the corresponding encoded features 211, 213 associated with each alignment output 272, each transcribed non-synthetic speech utterance 204, and each un-transcribed non-synthetic speech utterance 206 provided as input to the audio encoder 210. Pre-training the audio encoder 210 may include updating parameters of the audio encoder 210 based on the contrastive losses 252.

In some implementations, the contrastive loss part 200a uses one or more codebooks 225 instead of using a single codebook 225. For example, the contrastive loss part 200a may use sixteen (16) codebooks 225. More specifically, the audio encoder 210 generates N number of contrastive context vectors 215 (e.g., probability predictions output from the audio encoder 210) using a corresponding N number of softmax output layers for each encoded feature 211, 213. This is in contrast to generating a single contrastive context vector 215 for each encoded feature 211, 213 using a single codebook 225. To that end, the contrastive loss part 200a randomly initializes N number of different codebooks 225 and, using each respective codebook 225 of the N number of codebooks 225, to finds a respective nearest vector where an index of the vector includes the corresponding label 229 of the respective codebook 225. By using multiple codebooks 225, the contrastive loss part 200a compares N number of contrastive context vectors 215 to a corresponding N number of labels 229 for each encoded feature 211, 213. Advantageously, using multiple codebooks 225 enables the contrastive loss part 200a to improve stability and convergence of the audio encoder 210 during training. In some examples, the contrastive loss part 200a trains the audio encoder 210 using equal weights for each softmax layer output of the audio encoder 210.

Referring now specifically to FIG. 2B, the supervised loss part 200b of the pre-training process 200 is configured to inject lexical information into the audio encoder 210 during pre-training based on supervised loss terms 262, 264 derived from the transcribed non-synthetic speech utterances 204 and the alignment outputs 272 corresponding to unspoken textual utterances 202 output by the alignment model 270. Notably, the supervised loss part 200b leverages one or more auxiliary decoders 290 for generating the supervised loss terms 262, 264. The auxiliary decoders 290 may include Connectionist Temporal Classification (CTC) decoders, Listen, Attend and Spell (LAS) decoders, or RNN-T decoders. These auxiliary decoders 290 may include at least one of a phoneme decoder configured to decode a sequence of phonemes or a word piece decoder configured to decode a sequence of word pieces. The auxiliary decoders 290 could also include a grapheme decoder configured to decode a sequence of graphemes.

During the supervised loss part 200b, the text encoder 220 of the audio encoder 210 is configured to receive alignment outputs 272 (i.e., text embeddings) from the alignment model 270 and the speech encoder 230 is configured to receive transcribed non-synthetic speech utterances 204. That is, the text encoder 220 of the audio encoder 210 generates encoded textual representations 222 for alignment outputs 272 (e.g., corresponding to an unspoken textual utterance 202) and the speech encoder 230 of the audio encoder 210 generates encoded audio representations 234 for speech inputs (i.e., transcribed non-synthetic speech utterances 204). Here, the encoded textual representations 222 and the encoded audio representations 234 may not both be compatible with the auxiliary decoders 290. Thus, the audio encoder 210 may also include a shared encoder 240 that receives the encoded textual representations 222 as input, and generates a first encoded shared representation 242 (eₜₑₓₜ) as output. Moreover, the shared encoder 240 receives the encoded audio representations 234 as input, and generates a second encoded shared representation (eₛᵤₚ) 244 as output. Accordingly, the shared encoder 240 generates the first and second encoded shared representations 242, 244 into a shared latent representation space compatible with the auxiliary decoder 290.

In particular, the shared encoder 240 receives, as input, each encoded textual representation 222 that corresponds to the alignment output 272 generated from the unspoken textual utterance 202 and generates, as output, for each of a plurality of time steps, the first encoded shared representation (eₜₑₓₜ) 242 that corresponds to the alignment output 272 at the corresponding time step. The auxiliary decoder 290 including the phoneme decoder or the word piece decoder receives, as input, each first encoded shared representation 242 output from the shared encoder 240 and generates, as output, a first probability distribution 292 over possible speech recognition hypotheses for the corresponding alignment output 272 at the corresponding time step. In some examples, the first probability distribution 292 over possible speech recognition hypotheses includes one of possible phoneme labels, possible word piece labels, or possible grapheme labels. Thereafter, a supervised loss module 260 may determine an alignment output loss term 262 based on the first probability distribution 292 over possible speech recognition hypotheses for the alignment output 272 corresponding to the unspoken textual utterance 202. Here, the corresponding unspoken textual utterance 202 in which the alignment output 272 is generated from also serves as a ground-truth transcription 208. The supervised loss part 200b may pre-train the audio encoder 210 on the alignment output loss term 262 by updating parameters of the audio encoder 210 using the alignment output loss term 262.

Similarly, during the supervised loss part 200b, the shared encoder 240 receives, as input, each transcribed encoded audio representation 234 that corresponds to the transcribed non-synthetic speech utterance 204 and generates, as output, for each of a plurality of time steps, a second encoded shared representation (eₛᵤₚ) 244 that corresponds to the transcribed non-synthetic speech utterance 204 at the corresponding time step. The auxiliary decoder 290 including the phoneme decoder or the word piece decoder receives, as input, each second encoded shared representation 244 output from the shared encoder 240 and generates, as output, a second probability distribution 294 over possible non-synthetic speech recognition hypotheses for the corresponding transcribed non-synthetic speech utterance 204 at the corresponding time step. In some examples, the second probability distribution 294 over possible non-synthetic speech recognition hypotheses includes the one of possible phoneme labels, the possible word piece labels, or the possible grapheme labels. Thereafter, the supervised loss module 260 may determine a non-synthetic speech loss term 264 based on the second probability distribution 294 over possible non-synthetic speech recognition hypotheses and the corresponding transcription 208 paired with the transcribed non-synthetic speech utterance 204. Here, the corresponding transcription 208 serves as a ground-truth transcription and may include a sequence of target phonemes, target word pieces, and/or target graphemes. The supervised loss part 200b may pre-train the audio encoder 210 on the non-synthetic speech loss term 264 by updating parameters of the audio encoder 210 using the non-synthetic speech loss term 264.

In some implementations, the supervised loss part 200b of the pre-training process 200 uses another auxiliary decoder 290 to generate a third probability distribution 293 over possible speech recognition hypotheses based on the first encoded shared representation (eₜₑₓₜ) 242 for the alignment output 272 at the corresponding time step, whereby the supervised loss module 260 may determine another alignment output loss term 262 based on the third probability distribution 293 and the unspoken textual utterance 202 corresponding to the alignment output 272. Here, the other auxiliary decoder 290 includes the other one of the phoneme decoder, word piece decoder, or the grapheme decoder and the third probability distribution 293 over possible speech recognition hypotheses includes the other one of the possible phoneme labels, the possible word piece labels, or the possible grapheme labels. In these implementations, the other auxiliary decoder 290 also generates a fourth probability distribution 295 over possible non-synthetic speech recognition hypotheses for the corresponding second encoded shared representation 244 at the corresponding time step, whereby the supervised loss module 260 may determine another non-synthetic speech loss term 264 based on the fourth probability distribution 295 and the corresponding transcription 208 that is paired with the transcribed non-synthetic speech representation 204. Here, the fourth probability distribution 295 over possible non-synthetic speech recognition hypotheses includes the other one of the possible phoneme labels, the possible word piece labels, or the possible grapheme labels. The supervised loss part 200b of the pre-training process 200 may similarly pre-train the audio encoder 210 on the other alignment output loss term 262 and the other non-synthetic speech loss term 264.

The un-transcribed non-synthetic speech utterances 206 and the unspoken textual utterances 202 each correspond to “unpaired” training data whereby the contrastive loss (L_{w2v}) 252 derived from the unspoken textual utterances (Xₜₑₓₜ) 202 may be combined with the supervised loss [symbol] associated with the alignment output loss term 262 to obtain an unspoken textual loss function, [symbol] as follows.

$${𝒥}_{text} = {ℒ}_{w 2 v} ( x \vert {θ}_{e} ) + {ℒ}_{aux} ( y \vert x , {θ}_{e} , {θ}_{d} ) \qquad ( 2 )$$

Likewise, the contrastive loss (L_{w2v}) 252 derived from the un-transcribed non-synthetic speech utterances (Xᵤₙₛᵤₚ) 206 may be used to express an unsupervised speech loss function, [symbol] , as follows.

$${𝒥}_{unsup \_ speech} = {𝒥}_{w 2 v} ( {x}^{*} \vert {θ}_{e} ) \qquad ( 3 )$$

During pre-training of the audio encoder 210, the alignment outputs 272 and the un-transcribed non-synthetic speech utterances 206 may be separated or mixed within each batch. In order to force the audio encoder 210 to learn representations that are effective for both alignment outputs 272 corresponding to unspoken textual utterances 202 and non-synthetic (human/real) speech, the loss mask a is applied when combining the loss functions [symbol] and [symbol] of Equations 2 and 3 to obtain an unpaired data loss function, [symbol] as follows.

$${𝒥}_{unpaired} = {σ𝒥}_{text} + ( 1 - σ ) {𝒥}_{speech} \qquad ( 4 )$$

The transcribed non-synthetic speech utterances 204 corresponds to “paired” and “supervised” training data whereby the derived contrastive loss L_{w2v} and the derived supervised loss [symbol] associated with the non-synthetic speech loss term 264 may be combined to obtain a paired data loss function, [symbol] , as follows.

$${𝒥}_{paired} = {ℒ}_{w 2 v} ( x \vert {θ}_{e} ) + {ℒ}_{aux} ( y \vert x , {θ}_{e} , {θ}_{d} ) \qquad ( 5 )$$

Lastly, the pre-training process 200 may combine the unpaired data loss function ( [symbol] ) and the paired data loss function ( [symbol] ) to obtain an overall loss term, [symbol] , that may be expressed as follows.

$${𝒥}_{tts 4 pretrain 2} = {𝒥}_{unpaired} + {λ}_{1} 𝒥paired \qquad ( 6 )$$

where λ₁ may be equal to 1.0. The pre-training process 200 may pre-train the audio encoder 210 using the overall loss term, [symbol] , by updating parameters of the audio encoder 210 to effectively teach the audio encoder 210 to learn shared representations between speech and text.

In some implementations, the pre-training process 200 for pre-training the audio encoder 210 applies encoder consistency regularization. Unlike decoder consistency regularization, encoder consistency regularization does not require hypothesized labels and therefore has the advantage of being able to be applied to all the training data 201. Encoder consistency regularization may be applied via Hierarchical Contrastive consistency Regularization (HCCR) techniques where encoder activations e, e* from original/non-augmented and augmented speech are projected through an auxiliary network to generate z and z*. Thereafter, positive and negative pairs are constructive and a contrastive loss l_{t,z,z*} is calculated as follows.

$${l}_{t , z , {z}^{*}} = - log \frac{exp ( sim ( {z}_{t}^{*} , {z}_{t} ) / τ )}{{\sum }_{k = 1}^{T} exp ( sim ( {z}_{t}^{*} , {z}_{k} ) / τ )} \qquad ( 7 )$$

Specific to HCCR, a Convolutional Neural Network (CNN) projection network may calculate projections over increasing length segments of encoder activations e (30, 50, 120 ms) to yield 3 views (V) and draw negative examples from the same utterance for short segments, and from other utterances in the batches with 120 ms segments. Accordingly, an HCCR loss may be calculated over the transcribed non-synthetic speech utterances 204 (paired speech), the un-transcribed non-synthetic speech utterances 206 (unpaired speech), and the alignment outputs 272 generated from the unspoken textual utterances 202 as follows.

$${ℒ}_{enc \_ cons} = {\sum }_{ν = 1}^{V} {\sum }_{t = 1}^{{T}^{( v )}} {l}_{t , {z}^{* ( v )} , {z}^{( v )}} \qquad ( 8 )$$

The HCCR loss calculated by Equation 8 may be added to Equation 6 with a coefficient of 1e-3 as part of the overall loss term, [symbol] , for use in pre-training the audio encoder 210.

Implementations described above describe the pre-training process 200 for pre-training the audio encoder 210, however, it is understood that the pre-training process 200 may also be employed to train/pre-train a monolingual ASR model or a multilingual ASR model. In some instances, the pre-training process 200 may be employed to train end-to-end ASR models with decoder structures (i.e., non-pre-training) or fine-tune an ASR model to perform downstream tasks such as speech translation or natural language understanding. Moreover, the pre-training process 200 may be used with training data sources including unspoken textual utterances 202, transcribed non-synthetic speech utterances 204, and un-transcribed non-synthetic speech utterances 206 independently, or using some combination thereof.

Referring now to FIG. 3, in some implementations, a fine-tuning process 300 fine-tunes the pre-trained audio encoder 210 after the pre-training process 200 (FIGS. 2A and 2B). The fine-tuning process 300 obtains supervised speech recognition training data 301 to teach the pre-trained audio encoder 210 to generate audio encoder posteriors 312 over a first vocabulary of output labels. The first vocabulary of output labels is different than the second vocabulary of output labels learned during the pre-training process 200. The fine-tuning process 300 may involve adding an output layer 314 (e.g., a linear projection layer) to the pre-trained audio encoder 210. The first vocabulary of output labels includes a vocabulary of a pre-trained LLM 440 (FIG. 4) plus an additional special token (e.g., a Connectionist Temporal Classification (CTC) “blank” token) that is not included in the vocabulary of the pre-trained LLM. The supervised speech recognition training data 301 includes transcribed speech utterances 302 each paired with a corresponding ground-truth transcription 306 and including a corresponding sequence of audio features 304.

For each transcribed speech utterance 302, the pre-trained audio encoder 210 processes the corresponding sequence of audio features 304 to generate a corresponding sequence of audio encoder posteriors 312. Specifically, the pre-trained audio encoder 210 transforms the sequence of audio features 304 into hidden representations, and the output layer 314 projects the hidden representations to logits. The pre-trained audio encoder applies a softmax function to the logits to generate the audio encoder posteriors 312 where the corresponding sequence of audio encoder posteriors 312 over the first vocabulary of output labels includes a probability distribution over possible word piece labels. In some examples, an auxiliary decoder 320 (which may represent the decoding logic associated with the output layer 314) decodes the corresponding sequence of audio encoder posterior 312 to generate a corresponding speech recognition result 322. Thereafter, a loss module 330 determines a supervised loss 332 (e.g., a CTC loss) by comparing the corresponding speech recognition result 322 (or the audio encoder posteriors 312 directly) to the corresponding ground-truth transcription 306. The fine-tuning process 300 fine-tunes the pre-trained audio encoder 210 (including the output layer 314) on the supervised loss 332 determined for the transcribed speech utterances 302. Thus, the pre-trained audio encoder 210 is initially pre-trained to encode speech representations for speech recognition or automatic speech translation tasks that use the second vocabulary of output labels different than the first vocabulary of output labels. Thereafter, the fine-tuning process 300 fine-tunes the pre-trained audio encoder to teach the pre-trained audio encoder 210 to generate audio encoder posteriors 312 over the first vocabulary of output labels.

In some implementations, the fine-tuning process 300 adds the output layer 314 to the pre-trained audio encoder 210 to generate the corresponding sequence of audio encoder posteriors 312 over the first vocabulary of output labels. The fine-tuning process 300 results in the fine-tuned audio encoder 310 which includes the output layer 314. The resulting audio encoder posteriors 312 represent a probability distribution over the first vocabulary (the LLM vocabulary plus the blank token) for each time step.

Referring now to FIG. 4, in some implementations, a fine-tuning process 400 employs the fine-tuned audio encoder 310 (e.g., after the fine-tuning process 300 (FIG. 3)) to fine-tune the pre-trained LLM 440 to perform speech recognition or automatic speech translation (AST) tasks. Notably, parameters of the fine-tuned audio encoder 310 are held fixed (i.e., not updated) while fine-tuning the pre-trained LLM 440 based on cross-entropy loss terms 452. The fine-tuning process 400 receives training data 401 that includes a corpus of transcribed speech utterances 402. Each transcribed speech utterance 402 is paired with a corresponding ground-truth transcription 406 and includes a corresponding sequence of audio features 404. The corpus of transcribed speech utterances 402 may include multilingual transcribed speech utterances.

For each corresponding transcribed speech utterance 402, the fine-tuned audio encoder 310 processes the corresponding sequence of audio features 404 to generate a corresponding sequence of audio encoder posteriors 312 over the first vocabulary of output labels. The fine-tuned audio encoder 310 may include the output layer 314 that generates the corresponding sequence of audio encoder posteriors 312 over the first vocabulary of output labels. The corresponding sequence of audio encoder posteriors 312 over the first vocabulary of output labels may include a probability distribution over possible word piece labels. In some examples, the fine-tuned audio encoder 310 applies a temperature parameter (T) to the output layer 314 to control a sharpness of the probability distribution. For instance, when the temperature parameter (T) is greater than one, the probability distribution may become flatter, and when temperature parameter (T) is less than one, the probability distribution may become sharper represented by:

$${o}_{t}^{( i )} = \frac{exp ( {z}_{t}^{( i )} / τ )}{{\sum }_{j = 1}^{\vert V \vert + 1} exp ( {z}_{t}^{( j )} / τ )} \qquad ( 9 )$$

where oₜ represents the audio encoder posteriors 312, |V| is the size of the pre-trained LLM 440 vocabulary, and zₜ represents the probability distribution.

The first vocabulary of output labels may include the vocabulary of the pre-trained LLM 440 (e.g., 256k tokens) plus an additional special token that is not included in the vocabulary of the pre-trained LLM 440. The first vocabulary of output labels may also include an additional special token (e.g., the CTC “blank” token <blk>) that is not included in the standard vocabulary of the pre-trained LLM 440. In some examples, the probability associated with the additional special token (e.g., <blk>) is suppressed or downscaled (e.g., by a log scalar value (blk_{downscale})) prior to computing the weighted sum 424 to enhance a representation of meaningful tokens to create an enhanced probability distribution (\hat{z}ₜ) represented by:

$${\hat{Z}}_{t}^{< blk >} = {Z}_{t}^{< blk >} - log ( {blk}_{downscale} ) \qquad ( 10 )$$

In some implementations, the fine-tuned audio encoder 310 may operate over a vocabulary that differs from that of the pre-trained LLM 440 (e.g., a smaller (e.g., 16k) vocabulary compared to the larger (e.g., 256k) vocabulary of the pre-trained LLM 440). To handle the mismatch, a randomly initialized auxiliary input embedding table may be trained jointly to map encoder logits/posteriors to the pre-trained LLM 440 embedding space (i.e., the vector space defined by the input embedding table 444). Specifically, the auxiliary input embedding table includes a set of trainable vectors corresponding to the size of the first vocabulary of the audio encoder. The embedding model 420 uses this auxiliary table to compute the weighted sum 424, effectively bypassing the token mismatch. During the fine-tuning process 400, the weights of the auxiliary table are updated while the weights of the fine-tuned audio encoder 310 remain frozen. This allows the fine-tuning process 400 to bridge a granular audio encoder vocabulary (e.g., 16,384 tokens) with a much larger LLM vocabulary (e.g., 256,000 tokens) without requiring the audio encoder to be retrained on the larger vocabulary. The randomly initialized auxiliary input embedding table receives, at each time step, either the encoder logits or posteriors defined over the encoder's vocabulary and maps them into the LLM input embedding space to produce speech embeddings compatible with the pre-trained LLM 440. The randomly initialized auxiliary input embedding table effectively maps the fine-tuned audio encoder 310 output logits to the pre-trained LLM 440 input space. This arrangement preserves the standardized posterior-matrix interface while providing robustness to vocabulary mismatches, enabling reuse of pre-existing encoders and facilitating incremental upgrades of either component without retraining the other, provided that the auxiliary mapping is included in the adaptation of the LLM.

For each corresponding transcribed speech utterance 402 in the corpus of transcribed speech utterances 402, the embedding model 420 receives the sequence of audio encoder posteriors 312 to determine a sequence of speech embeddings 422. That is, to align the sequence of audio encoder posteriors 312 with the text embedding space of the pre-trained LLM 440, the embedding model 420 determines the sequence of speech embeddings 422. The input embedding table 444 is a parameter matrix of the pre-trained LLM 440 including a collection of embedding vectors, where each embedding vector corresponds to a unique token in the vocabulary of the pre-trained LLM 440. The input embedding table 444 maps discrete token indices to dense vector representations suitable for processing by the pre-trained LLM 440. Specifically, the embedding model 420 determines the sequence of speech embeddings 422 by computing a weighted sum 424 (sₜ) of the input embedding table 444 (E) of the pre-trained LLM 440 from the corresponding sequence of audio encoder posteriors 312 (oₜ). The weighted sum 424 may be computed using the probability distributions over possible word piece labels from the corresponding sequence of audio encoder posteriors 312 as weights (oₜ) represented by:

$${s}_{t} = E \cdot {o}_{t} \qquad ( 11 )$$

When the first vocabulary includes the additional special token (e.g., <blk>) not present in the input embedding table 444, the weighted sum 424 may be computed over the entries of the input embedding table 444 corresponding to the vocabulary of the pre-trained LLM 440, effectively filtering out the additional special token.

In some implementations, the embedding model 420 selects a top-K subset of token predictions it from the sequence of audio encoder posteriors 312 at each frame, such that the weighted sum 424 is computed using only the top-K token predictions as multipliers. The embedding reconstruction is constrained to a top-K subset of token predictions it at each time step to reduce computation while preserving salient probabilistic information. In some examples, for each frame t, the embedding model 420 identifies the indices iₜ of the K highest-scoring tokens from the fine-tuned audio encoder 310 output audio encoder posteriors 312 (or logits) and applies a softmax operation restricted to those indices to obtain a re-normalized probability distribution over the top-K tokens. The embedding model 420 determines the sequence of speech embeddings 422 sₜ as a weighted sum of the corresponding entries from the input embedding table 444 (E) of the large language model (LLM) 440, using the re-normalized probabilities as weights represented by:

$${i}_{t} = arg {max}_{k} ( {z}^{t} ) \qquad ( 12 )$$

$${\tilde{s}}_{t} = E [ {i}_{t} ] \cdot soft max ( {z}_{t} [ {i}_{t} ] ) \qquad ( 13 )$$

where iₜ are the indices of the top-K values. In other examples, the token embeddings of input embedding table 444 (E) associated with the top-K subset of token predictions it are concatenated and mapped to the pre-trained LLM 440 embedding dimension through a linear projection layer. The projection layer may be randomly initialized and jointly optimized during adaptation of the pre-trained LLM 440 so that the projected vector aligns to the pre-trained input space of the LLM 440 input space. Either example may be employed alone or in combination with other techniques described herein, and K may be selected adaptively or fixed by configuration to balance accuracy and efficiency.

The fine-tuning process 400 may employ a concatenator 430 that generates a concatenation 432 of the corresponding sequence of speech embeddings 422 and the sequence of text embeddings 436. For each corresponding transcribed speech utterance 402 in the corpus of transcribed speech utterances 402, the pre-trained LLM 440 processes a concatenation 432 of the corresponding sequence of speech embeddings 422 and the corresponding sequence of text embeddings 436 to generate a corresponding predicted sequence of output labels 442. The sequence of text embeddings 436 is representative of the corresponding ground-truth transcription 406 and includes vector representations of tokens from the corresponding ground-truth transcription 406 obtained from the input embedding table 444. During training, the sequence of text embeddings 436 acts as the prefix or history (e.g., teacher-forcing) provided to the pre-trained LLM 440. By using the same input embedding table 444 to derive both the weighted sum 424 for the speech embeddings 422 and the sequence of text embeddings 436, the fine-tuning process 400 effectively aligns the audio and text modalities within the native input space of the pre-trained LLM 440. The pre-trained LLM 440 processes the concatenation 432 to generate the corresponding predicted sequence of output labels 442 (e.g., the next predicted token in the sequence).

For each corresponding transcribed speech utterance 402 in the corpus of transcribed speech utterances 402, a loss module 450 determines a cross-entropy loss term 452 based on the corresponding predicted sequence of output labels 442 and the corresponding ground-truth transcription 406. The fine-tuning process 400 fine-tunes the parameters of the pre-trained LLM 440 based on the cross-entropy loss terms 452 determined for the corpus of transcribed speech utterances 402. As noted previously, the parameters of the fine-tuned audio encoder 310 may be held fixed while the pre-trained LLM 440 is fine-tuned based on the cross-entropy loss terms 452. This architecture allows the pre-trained LLM 440 to be adapted to outputs from different speech encoders in a zero-shot fashion effectively. To promote modularity, the system is configured so that, after fine-tuning the pre-trained LLM 440, the pre-trained LLM 440 can accept posterior matrices emitted by different audio encoders trained on different datasets or domains in a zero-shot manner, i.e., without further re-tuning of the LLM, so long as the posterior vocabulary is compatible with the pre-trained LLM 440 vocabulary or is mapped thereto using the auxiliary input embedding table described above. In this implementation, the fine-tuned audio encoder 310 can be replaced, upgraded, or domain-adapted independently of the pre-trained LLM 440, and the pre-trained LLM 440 processes the new encoder's posteriors directly to generate outputs, thereby reducing retraining cost, simplifying deployment, and accommodating heterogeneous encoder training regimes while preserving end-to-end functionality.

In some examples, the corresponding sequence of audio features 404 of the transcribed speech utterance 402 characterizes an utterance spoken in a source language and the corresponding ground-truth transcription 406 includes translated text corresponding to a translation of the spoken utterance in a target language different than the source language. In these examples, processing the concatenation 432 of the corresponding sequence of speech embeddings 422 and the sequence of text embeddings 436 representative of the corresponding ground-truth transcription 406 further includes processing, by the pre-trained LLM 440, the concatenation 432 of the corresponding sequence of speech embeddings 422 and the sequence of text embeddings 436 representative of the corresponding ground-truth transcription 406 conditioned on a natural language automatic speech translation (AST) prompt to generate the corresponding predicted sequence of output labels 442. The natural language AST prompt instructs the pre-trained LLM 440 to generate the corresponding predicted sequence of output labels 442 in the target language. For example, the natural language AST prompt may include “Translate the [source language] speech into [target language] text” or “Convert this [source language] audio recording into [target language] text.” The natural language AST prompt is also tokenized and converted into embeddings using the input embedding table 444 and included in the input context (e.g., prepended to the sequence of text embeddings 436) processed by the pre-trained LLM 440. The corresponding sequence of audio encoder posteriors 312 over the first vocabulary of output labels may be in the source language. That is, the pre-trained LLM 440 receives a concatenation 432 of the speech embeddings 422 reconstructed from the source-language posteriors and text embeddings 436 corresponding to the selected AST prompt, and is configured to autoregressively output target-language tokens. This conditioning allows the same architecture to support multiple translation directions and prompt styles without architectural changes, while retaining the modular posterior interface described herein.

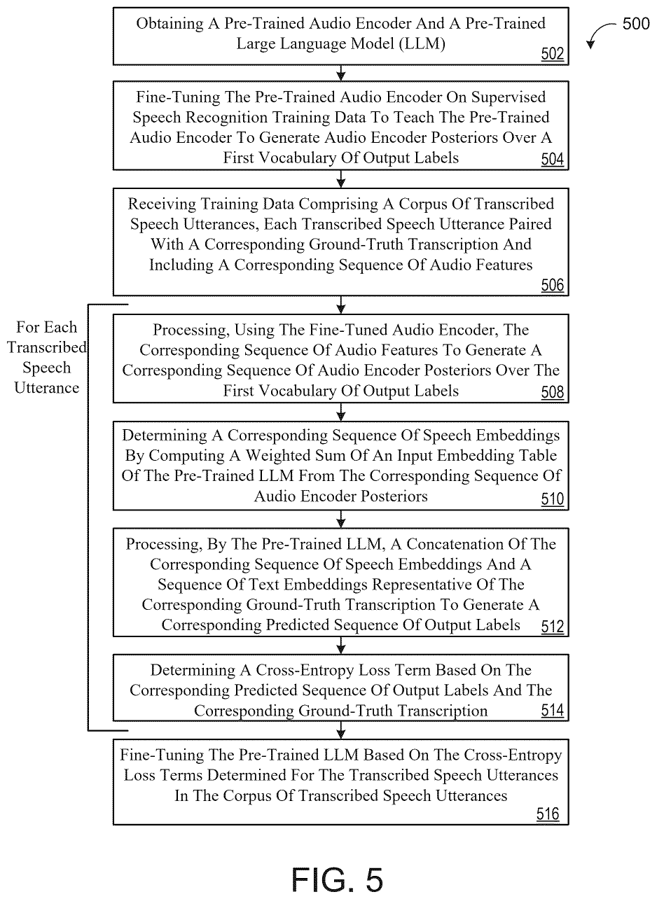

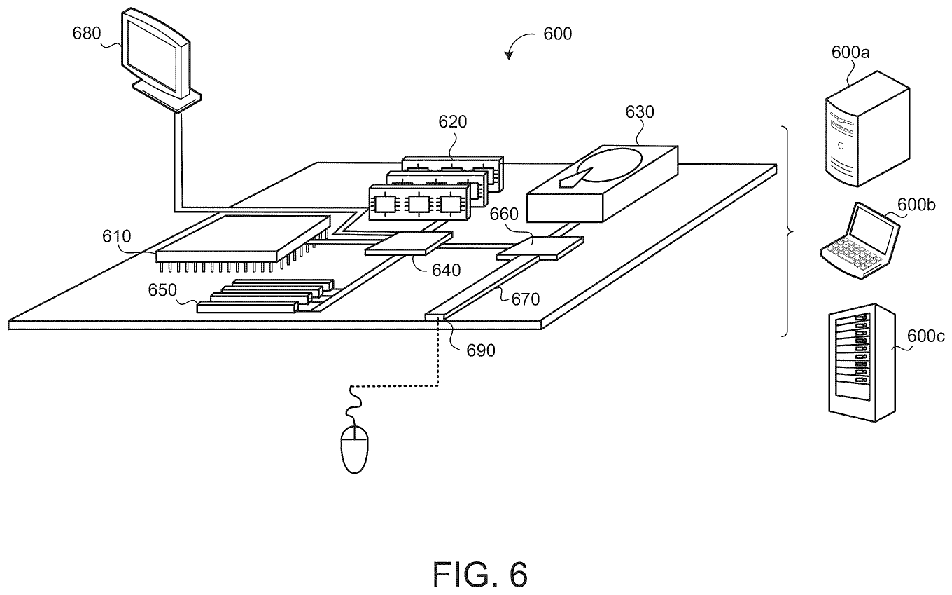

FIG. 5 is a flowchart of an example arrangement of operations for a computer-implemented method 500 for modular integration of automatic speech recognition and large language models. The method 500 may execute on data processing hardware 610 (FIG. 6) using instructions stored on memory hardware 620 (FIG. 6). The data processing hardware 610 and the memory hardware 620 may reside on the user device 110 and/or the remote computing system 140 of FIG. 1 each corresponding to the computing device 600 (FIG. 6).

At operation 502, the method 500 includes obtaining a pre-trained audio encoder 210 and a pre-trained large language model (LLM) 440. At operation 504, the method 500 includes fine-tuning the pre-trained audio encoder 210 on supervised speech recognition training data 301 to teach the pre-trained audio encoder 210 to generate audio encoder posteriors 312 over a first vocabulary of output labels. At operation 506, the method 500 includes receiving training data 401 that includes a corpus of transcribed speech utterances 402. Each transcribed speech utterance 402 is paired with a corresponding ground-truth transcription 406 and includes a corresponding sequence of audio features 404. For each corresponding transcribed speech utterance 402 in the corpus of transcribed speech utterances 402, the method 500 performs operations 508-514. At operation 508, the method 500 includes processing, using the fine-tuned audio encoder 310, the corresponding sequence of audio features 404 to generate a corresponding sequence of audio encoder posteriors 312 over the first vocabulary of output labels. At operation 510, the method 500 includes determining a corresponding sequence of speech embeddings 422 by computing a weighted sum 424 of an input embedding table 444 of the pre-trained LLM 440 from the corresponding sequence of audio encoder posteriors 312. At operation 512, the method 500 includes processing, by the pre-trained LLM 440, a concatenation 432 of the corresponding sequence of speech embeddings 422 and a sequence of text embeddings 436 representative of the corresponding ground-truth transcription 406 to generate a corresponding predicted sequence of output labels 442. At operation 514, the method 500 includes determining a cross-entropy loss term 452 based on the corresponding predicted sequence of output labels 442 and the corresponding ground-truth transcription 406. At operation 516, the method 500 includes fine-tuning the pre-trained LLM 440 based on the cross-entropy loss terms 452 determined for the transcribed speech utterances 402 in the corpus of transcribed speech utterances 402.

The fine-tuning process 400 provides technical advantages by enabling the pre-trained LLM 440 to effectively process speech information through a modular interface of audio encoder posteriors 312. Conventional techniques, such as AEC, primarily rely on discrete text hypotheses or N-best lists to correct recognition errors. However, these text-based methods often discard valuable acoustic confidence information and suffer from error propagation where the LLM cannot recover from initial transcription errors. By fine-tuning the pre-trained LLM 440 on a sequence of speech embeddings 422 constructed via a weighted sum 424 of the input embedding table 444, the fine-tuning process effectively preserves the probabilistic information from the fine-tuned audio encoder 310. This approach mitigates the information loss associated with converting speech to discrete text, allowing the pre-trained LLM 440 to leverage semantic reasoning capabilities on a richer, continuous representation of the speech signal.

Advantageously, the disclosed fine-tuning approach facilitates a zero-shot system combination capability. Unlike speech prompt methods that tightly couple the LLM to the specific continuous output space of a single speech encoder, the claimed method bridges the models using a standardized vocabulary space. This is achieved by using the audio encoder posteriors 312 to reconstruct embeddings within the LLM's 440 own embedding space. This technical implementation provides greater flexibility, enabling the fine-tuned audio encoder 310 to be replaced or updated with a different encoder without requiring the pre-trained LLM 440 to be re-tuned. Consequently, the system can adapt to new acoustic domains or upgraded encoders more efficiently than tightly integrated end-to-end models.

Moreover, the architecture of the embedding model 420 presents a further improvement in computational efficiency and privacy. By employing the weighted sum 424 mechanism, the system avoids the prohibitive context length increases associated with processing concatenated N-best lists in conventional AEC systems. Additionally, utilizing audio encoder posteriors 312 rather than raw continuous audio features or intermediate encoder states serves to protect speaker privacy by limiting the exposed data to linguistic probability distributions. This integration enables the pre-trained LLM 440 to perform high-performance speech recognition and translation tasks while maintaining modularity and computational efficiency.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
obtaining a pre-trained audio encoder and a pre-trained large language model (LLM);
fine-tuning the pre-trained audio encoder on supervised speech recognition training data to teach the pre-trained audio encoder to generate audio encoder posteriors over a first vocabulary of output labels;
receiving training data comprising a corpus of transcribed speech utterances, each transcribed speech utterance paired with a corresponding ground-truth transcription and comprising a corresponding sequence of audio features;
for each corresponding transcribed speech utterance in the corpus of transcribed speech utterances:
processing, using the fine-tuned audio encoder, the corresponding sequence of audio features to generate a corresponding sequence of audio encoder posteriors over the first vocabulary of output labels;
determining a corresponding sequence of speech embeddings by computing a weighted sum of an input embedding table of the pre-trained LLM from the corresponding sequence of audio encoder posteriors;
processing, by the pre-trained LLM, a concatenation of the corresponding sequence of speech embeddings and a sequence of text embeddings representative of the corresponding ground-truth transcription to generate a corresponding predicted sequence of output labels;
determining a cross-entropy loss term based on the corresponding predicted sequence of output labels and the corresponding ground-truth transcription; and
fine-tuning the pre-trained LLM based on the cross-entropy loss terms determined for the transcribed speech utterances in the corpus of transcribed speech utterances.

2. The computer-implemented method of claim 1, wherein parameters of the fine-tuned audio encoder are held fixed while fine-tuning the pre-trained LLM based on the cross-entropy loss terms.

3. The computer-implemented method of claim 1, wherein the first vocabulary of output labels comprises a vocabulary of the pre-trained LLM plus an additional special token that is not included in the vocabulary of the pre-trained LLM.

4. The computer-implemented method of claim 3, wherein the pre-trained audio encoder is pre-trained to encode speech representations for speech recognition or automatic speech translation tasks that use a second vocabulary of output labels different than the first vocabulary of output labels.

5. The computer-implemented method of claim 1, wherein the pre-trained audio encoder comprises a stack of multi-head attention layers.

6. The computer-implemented method of claim 5, wherein the stack of multi-head attention layers comprise Conformer layers or Transformer layers.

7. The computer-implemented method of claim 1, wherein the pre-trained audio encoder is pre-trained using a BERT-based Speech pre-Training with Random-projection Quantizer (BEST-RQ) training objective.

8. The computer-implemented method of claim 1, wherein the fine-tuned audio encoder comprises an output layer to generate the corresponding sequence of audio encoder posteriors over the first vocabulary of output labels.

9. The computer-implemented method of claim 1, wherein the corresponding sequence of audio encoder posteriors over the first vocabulary of output labels comprises a probability distribution over possible word piece labels.

10. The computer-implemented method of claim 1, wherein the corpus of transcribed speech utterances comprise multilingual transcribed speech utterances.

11. The computer-implemented method of claim 1, wherein:
the corresponding sequence of audio features of the transcribed speech utterance characterizes an utterance spoken in a source language and the corresponding ground-truth transcription comprises translated text corresponding to a translation of the utterance in a target language different than the source language; and
processing, by the pre-trained LLM, the concatenation of the corresponding sequence of speech embeddings and the sequence of text embeddings representative of the corresponding ground-truth transcription further comprises processing, by the pre-trained LLM, the concatenation of the corresponding sequence of speech embeddings and the sequence of text embeddings representative of the corresponding ground-truth transcription conditioned on a natural language automatic speech translation (AST) prompt to generate the corresponding predicted sequence of output labels, the natural language AST prompt instructing the pre-trained LLM to generate the corresponding predicted sequence of output labels in the target language.

12. The computer-implemented method of claim 11, wherein the corresponding sequence of audio encoder posteriors over the first vocabulary of output labels are in the source language.

13. The computer-implemented method of claim 1, wherein the pre-trained audio encoder is pre-trained by:
receiving an audio encoder and audio encoder pre-training data comprising a corpus of un-transcribed speech utterances, each un-transcribed speech utterance not paired with a corresponding transcription;
for each corresponding un-transcribed speech utterance in the corpus of un-transcribed speech utterances:
generating, at each of a plurality of output steps, using a random-projection quantizer, a target quantized vector token and a target token index for a corresponding audio feature in a sequence of audio features associated with the corresponding un-transcribed speech utterance, wherein the target token index maps the corresponding audio feature to the target quantized vector token stored in one or more codebooks;
after masking a subset of the audio features in the sequence of audio features associated with the corresponding un-transcribed speech utterance, generating, by the audio encoder, contrastive context vectors from corresponding masked audio features; and
deriving a contrastive loss term between the contrastive context vectors at the masked positions and the target token index; and
pre-training the audio encoder based on the contrastive loss terms.

14. The computer-implemented method of claim 13, wherein:
the audio encoder pre-training data further comprises:
a corpus of unspoken textual utterances, each unspoken textual utterance not paired with any corresponding spoken utterance; and
another corpus of transcribed speech utterances, each transcribed speech utterance in the other corpus of transcribed speech utterances paired with a corresponding transcription; and
the pre-trained audio encoder is further pre-trained by:
generating, using an alignment model, a corresponding alignment output for each unspoken textual utterance;
at each of a plurality of output steps for each alignment output:
generating, using an auxiliary decoder, a first probability distribution over possible speech recognition hypotheses for the corresponding alignment output; and
determining an alignment output loss term based on the first probability distribution over possible speech recognition hypotheses and the unspoken textual utterance corresponding to the alignment output;
at each of a plurality of output steps for each transcribed non-synthetic speech utterance:
generating, using the auxiliary decoder, a second probability distribution over possible speech recognition hypotheses for the corresponding transcribed non-synthetic speech utterance;
determining a speech loss term based on the second probability distribution over possible speech recognition hypotheses and the corresponding transcription paired with the transcribed non-synthetic speech utterance; and
pre-training the audio encoder based on the contrastive loss term, the alignment output loss term, and the speech loss term.

15. A system comprising:
data processing hardware; and
memory hardware in communication with the data processing hardware, the memory hardware storing instructions that when executed on the data processing hardware cause the data processing hardware to perform operations comprising:
obtaining a pre-trained audio encoder and a pre-trained large language model (LLM);
fine-tuning the pre-trained audio encoder on supervised speech recognition training data to teach the pre-trained audio encoder to generate audio encoder posteriors over a first vocabulary of output labels;
receiving training data comprising a corpus of transcribed speech utterances, each transcribed speech utterance paired with a corresponding ground-truth transcription and comprising a corresponding sequence of audio features;
for each corresponding transcribed speech utterance in the corpus of transcribed speech utterances:
processing, using the fine-tuned audio encoder, the corresponding sequence of audio features to generate a corresponding sequence of audio encoder posteriors over the first vocabulary of output labels;
determining a corresponding sequence of speech embeddings by computing a weighted sum of an input embedding table of the pre-trained LLM from the corresponding sequence of audio encoder posteriors;
processing, by the pre-trained LLM, a concatenation of the corresponding sequence of speech embeddings and a sequence of text embeddings representative of the corresponding ground-truth transcription to generate a corresponding predicted sequence of output labels;
determining a cross-entropy loss term based on the corresponding predicted sequence of output labels and the corresponding ground-truth transcription; and
fine-tuning the pre-trained LLM based on the cross-entropy loss terms determined for the transcribed speech utterances in the corpus of transcribed speech utterances.

16. The system of claim 15, wherein parameters of the fine-tuned audio encoder are held fixed while fine-tuning the pre-trained LLM based on the cross-entropy loss terms.

17. The system of claim 15, wherein the first vocabulary of output labels comprises a vocabulary of the pre-trained LLM plus an additional special token that is not included in the vocabulary of the pre-trained LLM.

18. The system of claim 17, wherein the pre-trained audio encoder is pre-trained to encode speech representations for speech recognition or automatic speech translation tasks that use a second vocabulary of output labels different than the first vocabulary of output labels.

19. The system of claim 15, wherein the pre-trained audio encoder comprises a stack of multi-head attention layers.

20. The system of claim 19, wherein the stack of multi-head attention layers comprise Conformer layers or Transformer layers.

21. The system of claim 15, wherein the pre-trained audio encoder is pre-trained using a BERT-based Speech pre-Training with Random-projection Quantizer (BEST-RQ) training objective.

22. The system of claim 15, wherein fine-tuned audio encoder comprises an output layer to generate the corresponding sequence of audio encoder posteriors over the first vocabulary of output labels.

23. The system of claim 15, wherein the corresponding sequence of audio encoder posteriors over the first vocabulary of output labels comprises a probability distribution over possible word piece labels.

24. The system of claim 15, wherein the corpus of transcribed speech utterances comprise multilingual transcribed speech utterances.

25. The system of claim 15, wherein:
the corresponding sequence of audio features of the transcribed speech utterance characterizes an utterance spoken in a source language and the corresponding ground-truth transcription comprises translated text corresponding to a translation of the spoken utterance in a target language different than the source language; and
processing, by the pre-trained LLM, the concatenation of the corresponding sequence of speech embeddings and the sequence of text embeddings representative of the corresponding ground-truth transcription further comprises processing, by the pre-trained LLM, the concatenation of the corresponding sequence of speech embeddings and the sequence of text embeddings representative of the corresponding ground-truth transcription conditioned on a natural language automatic speech translation (AST) prompt to generate the corresponding predicted sequence of output labels, the natural language AST prompt instructing the pre-trained LLM to generate the corresponding predicted sequence of output labels in the target language.

26. The system of claim 25, wherein the corresponding sequence of audio encoder posteriors over the first vocabulary of output labels are in the source language.

27. The system of claim 15, wherein the pre-trained audio encoder is pre-trained by:
receiving an audio encoder and audio encoder pre-training data comprising a corpus of un-transcribed speech utterances, each un-transcribed speech utterance not paired with a corresponding transcription;
for each corresponding un-transcribed speech utterance in the corpus of un-transcribed speech utterances:
generating, at each of a plurality of output steps, using a random-projection quantizer, a target quantized vector token and a target token index for a corresponding audio feature in a sequence of audio features associated with the corresponding un-transcribed speech utterance, wherein the target token index maps the corresponding audio feature to the target quantized vector token stored in one or more codebooks;
after masking a subset of the audio features in the sequence of audio features associated with the corresponding un-transcribed speech utterance, generating, by the audio encoder, contrastive context vectors from corresponding masked audio features; and
deriving a contrastive loss term between the contrastive context vectors at the masked positions and the target token index; and
pre-training the audio encoder based on the contrastive loss terms.

28. The system of claim 27, wherein:
the audio encoder pre-training data further comprises:
a corpus of unspoken textual utterances, each unspoken textual utterance not paired with any corresponding spoken utterance; and
another corpus of transcribed speech utterances, each transcribed speech utterance in the other corpus of transcribed speech utterances paired with a corresponding transcription; and
the pre-trained audio encoder is further pre-trained by:
generating, using an alignment model, a corresponding alignment output for each unspoken textual utterance;
at each of a plurality of output steps for each alignment output:
generating, using an auxiliary decoder, a first probability distribution over possible speech recognition hypotheses for the corresponding alignment output; and
determining an alignment output loss term based on the first probability distribution over possible speech recognition hypotheses and the unspoken textual utterance corresponding to the alignment output;
at each of a plurality of output steps for each transcribed non-synthetic speech utterance:
generating, using the auxiliary decoder, a second probability distribution over possible speech recognition hypotheses for the corresponding transcribed non-synthetic speech utterance;
determining a speech loss term based on the second probability distribution over possible speech recognition hypotheses and the corresponding transcription paired with the transcribed non-synthetic speech utterance; and
pre-training the audio encoder based on the contrastive loss term, the alignment output loss term, and the speech loss term.
